(19) United States
(12) Patent Application Publication
(10) Pub. No.: US 2026/0264154 A1
(43) Pub. Date: Sep. 10, 2026

(54) TUBE CUTTER CAPABLE FOR CUTTING TUBES WITH VARIOUS DIAMETERS

(71) Applicant: YUNG CHI INDUSTRY CO., LTD., TAICHUNG (TW)

(72) Inventor: WU SHENG HUANG, TAICHUNG (TW)

(21) Appl. No.: 19/538,353

(22) Filed: Feb. 12, 2026

(30) Foreign Application Priority Data
Mar. 10, 2025 (TW) 114108654

(51) Int. Cl. B23D 21/08; B26D 3/16

(52) U.S. Cl. CPC B23D 21/08; B26D 3/169

(57) ABSTRACT

A tube cutter includes a main body having a cutting space; a cutting blade member movably disposed on the main body and partially located in the cutting space; a roller assembly movably disposed on the main body; and a control assembly connected to the roller assembly. The roller assembly includes a roller base, a first roller, and a second roller; the first roller being positioned closer to the opening than the second roller. The control assembly is operable to drive the roller assembly to move so as to change a distance between the roller assembly and the cutting blade member. Wherein an included angle between a first clamping point at which the tube contacts the cutting blade member and a second clamping point at which the tube contacts the first roller is always smaller than 180 degrees.

### BACKGROUND OF THE INVENTION

The present invention relates to hand tools, and more particularly to a tube cutter capable of stably clamping and cutting pipes of different sizes.

In engineering operations, various types of tubes (such as copper tubes, steel tubes, PVC flexible tubes, and the like) are often required. These tubes are typically manufactured with relatively long lengths; however, in practical applications, only a portion of a tube may be needed. In such cases, a cutting device is required to cut the tube into a desired length. Generally, tube cutting operations can be performed in advance at a factory by using a tube cutting machine that cuts a target tube by hydraulic or pneumatic actuation, and the cut tube is then transported to a job site for use. However, a tube cutting machine is a large machine tool, and not all engineering units are equipped with such equipment. When workers at a construction site need to perform tube cutting operations on a temporary basis, they must rely on a portable tube cutter to carry out the cutting operation.

One of the prior art includes a portable tube cutter in which a circular blade assembly and a roller assembly are mounted in a body. A driving assembly passes through the body and is connected to the roller assembly. A rotary operating member of the driving assembly is disposed outside the body, and a conversion unit connects the body, the driving assembly, and the roller assembly, such that rotational movement of the rotary operating member is converted into linear displacement of the roller assembly. In this manner, a relative distance between a roller of the roller assembly and a circular blade of the circular blade assembly can be adjusted, thereby allowing cutting of metal tubes having different diameters.

However, the above-described tube cutter has a drawback in that, when a tube to be cut has an excessively large size, an included angle between a first contact point at which the circular blade contacts the tube and a second contact point at which an outer roller of the roller assembly contacts the tube exceeds 180 degrees. Under such a condition, three-point positioning formed by the circular blade and the roller assembly cannot effectively clamp the tube therebetween. As a result, during a tube cutting operation, the tube may slip out of the tube cutter, making it impossible to perform the cutting operation.

Accordingly, how to provide an improved tube cutter that can effectively solve the above-mentioned problems has become an important issue to be addressed by those skilled in the relevant art and by research and development personnel.

### SUMMARY OF THE INVENTION

In view of the above, the primary object of the present invention is to provide a tube cutter capable for cutting tubes with various diameters, which can effectively improve stability and safety when clamping a tube.

In order to achieve the objective of the present invention, the present invention discloses a tube cutter, comprising: a main body having a cutting space, wherein one side of the main body has an opening in communication with the cutting space; a cutting blade member movably disposed on the main body, wherein at least a portion of the cutting blade member is located in the cutting space; a roller assembly movably disposed on the main body, the roller assembly including a roller base, a first roller, and a second roller, wherein the first roller and the second roller are respectively pivotally mounted on opposite sides of the roller base, and the first roller is positioned closer to the opening than the second roller; and a control assembly disposed on the main body and connected to the roller assembly, the control assembly being operable by a user to drive the roller assembly to move along a moving direction so as to change a distance between the roller assembly and the cutting blade member; wherein, when a tube is disposed in the cutting space, the cutting blade member, the first roller, and the second roller respectively abut against an outer wall surface of the tube; wherein a height of the first roller along the moving direction of the roller assembly is greater than a height of the second roller along the moving direction of the roller assembly, such that an included angle between a first clamping point at which the tube contacts the cutting blade member and a second clamping point at which the tube contacts the first roller is always smaller than 180 degrees..

In an embodiment, wherein the control assembly includes a cam, the cam being rotatably disposed in the main body, the cam having a first cam surface and a second cam surface, and the roller base having an abutting surface on a bottom side thereof; when the cam is rotated such that the first cam surface abuts against the abutting surface, the roller assembly is adjusted to a first height; when the cam is rotated such that the second cam surface abuts against the abutting surface, the roller assembly is adjusted to a second height.

In an embodiment, wherein the control assembly includes a knob rotatably disposed on one side of the main body and connected to the cam, such that the knob is operable to drive the cam to rotate; wherein the knob includes a plurality of auxiliary portions arranged radially and an indicator portion, the indicator portion being formed between two of the auxiliary portions, and a length of the indicator portion being shorter than lengths of the auxiliary portions.

In an embodiment, wherein the control assembly further including a positioning assembly having a positioning ball, a spring member, and a positioning plate; the positioning ball and the spring member being disposed in a through hole formed in the cam, a penetrating direction of the through hole being generally parallel to an axial direction of the cam; the positioning plate being disposed between the cam and the main body; wherein two ends of the spring member respectively abut against a bottom of the through hole and the positioning ball, such that the positioning ball protrudes from the through hole to abut against the positioning plate.

In an embodiment, wherein the positioning plate has a plurality of positioning holes distributed around the positioning plate, and positions of the positioning holes respectively correspond to positions of the positioning ball when respective cam surfaces of the cam contact the abutting surface.

In an embodiment, wherein the main body is provided with a stop block adjacent to one side of the cam; the cam further has a third cam surface, a fourth cam surface, and a stop surface; the third cam surface is adjacent to the second cam surface, the fourth cam surface is adjacent to the third cam surface, and the stop surface is adjacent to the fourth cam surface; when the first cam surface abuts against the abutting surface, the stop surface abuts against the stop block, such that the cam is prevented from further rotating in a direction toward the stop block.

In an embodiment, wherein the roller assembly includes two elastic members disposed on opposite sides of the roller base, extension directions of the two elastic members being generally parallel to the moving direction of the roller assembly; the two elastic members have two ends respectively abutting against the roller base and the main body, thereby applying an elastic force that biases the roller base to move in a direction away from the cutting blade member.

In an embodiment, wherein an outer diameter of the first roller is greater than an outer diameter of the second roller.

In an embodiment, a tube cutter, comprising: a main body having a cutting space, wherein one side of the main body has an opening in communication with the cutting space;

a cutting blade member movably disposed on the main body, wherein at least a portion of the cutting blade member is located in the cutting space; a roller assembly movably disposed on the main body, the roller assembly including a roller base, a first roller, and a second roller, wherein the first roller and the second roller are respectively pivotally mounted on opposite sides of the roller base, and the first roller is positioned closer to the opening than the second roller; and a control assembly disposed on the main body and connected to the roller assembly, the control assembly being operable by a user to drive the roller assembly to move along a moving direction so as to change a distance between the roller assembly and the cutting blade member; wherein, when a tube is disposed in the cutting space, the cutting blade member, the first roller, and the second roller respectively abut against an outer wall surface of the tube; wherein an outer diameter of the first roller is greater than an outer diameter of the second roller, such that an included angle between a first clamping point at which the tube contacts the cutting blade member and a second clamping point at which the tube contacts the first roller is always smaller than 180 degrees.

A preferred embodiment is described hereafter, accompanied with drawings, according to the objective and function of the present invention.

### BRIEF DESCRIPTION OF DRAWINGS

FIG. 1 is a perspective view of a first preferred embodiment of the present invention;

FIG. 2 is an exploded view of the first preferred embodiment of the present invention;

FIG. 3 is a partially enlarged view of the first preferred embodiment of the present invention, illustrating the structure of a roller assembly;

FIG. 4 is a partially enlarged schematic view of the first preferred embodiment of the present invention, illustrating the structure of a positioning assembly;

FIG. 5 is a cross-sectional schematic view of the first preferred embodiment of the present invention, illustrating a state in which the tube cutter clamps a tube;

FIG. 6 is a cross-sectional schematic view of a second preferred embodiment of the present invention, illustrating a state in which the tube cutter clamps a tube;

FIG. 7 is an exploded view of a third preferred embodiment of the present invention; and

FIG. 8 is a cross-sectional schematic view of the third preferred embodiment of the present invention, illustrating a state in which the tube cutter clamps a tube.

### DETAILED DESCRIPTION OF THE INVENTION

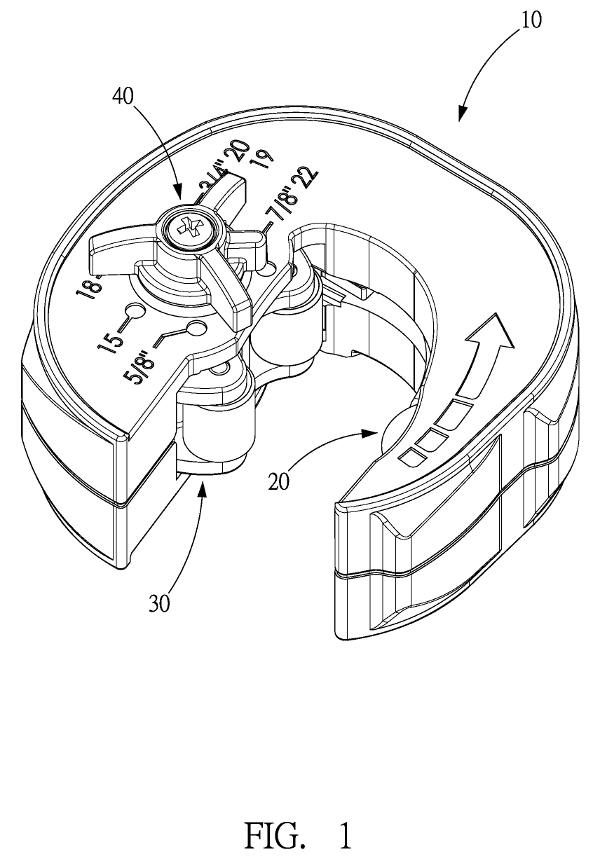

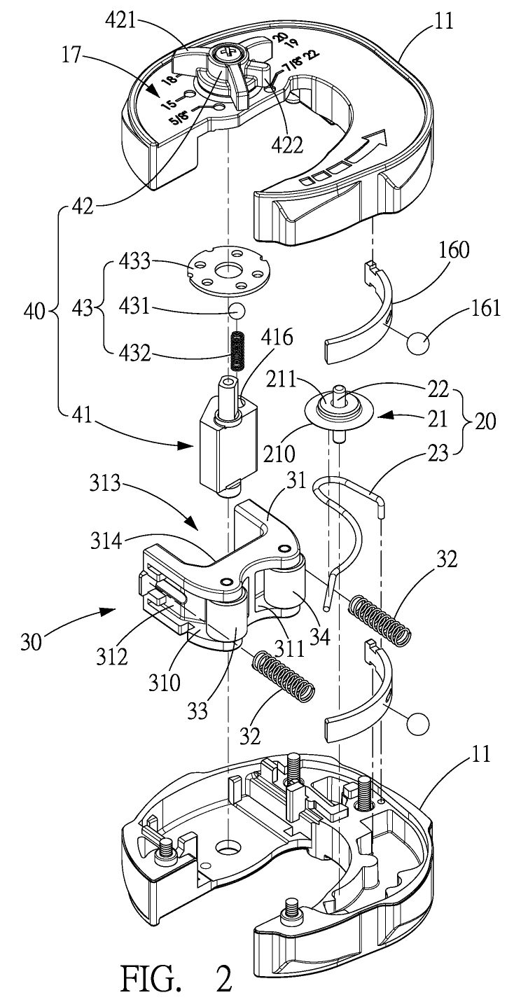

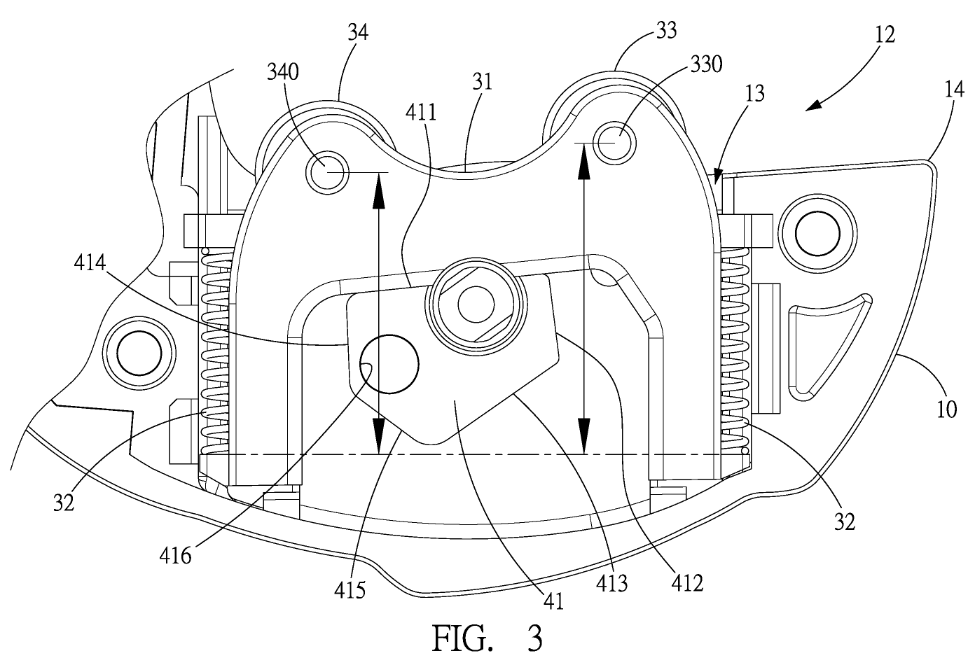

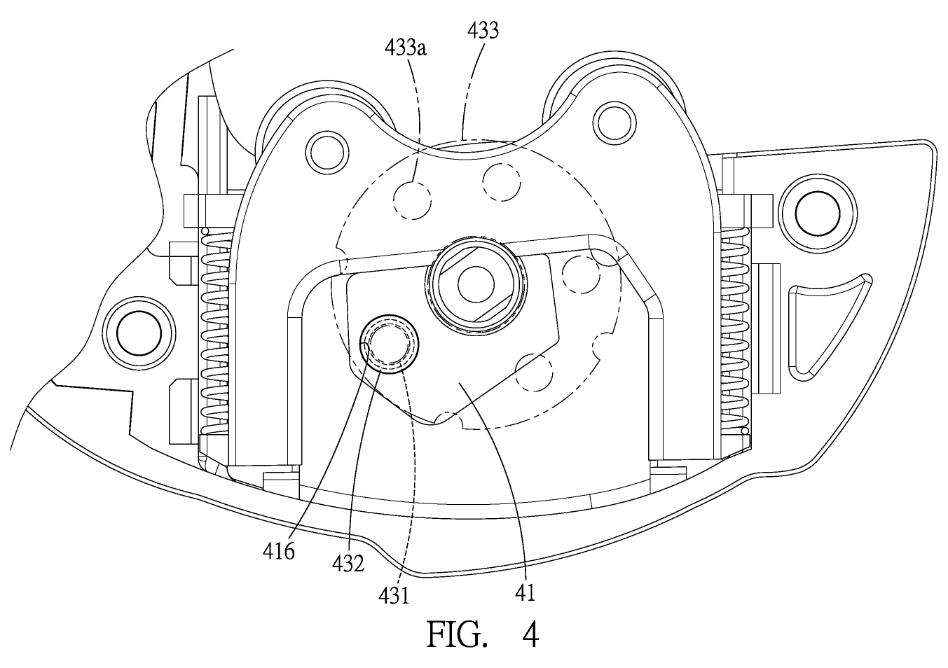

As shown in FIGS. 1 to 5, a tube cutter capable of cutting tubes with various diameters according to a first preferred embodiment of the present invention mainly comprises a main body 10, a cutting blade member 20, a roller assembly 30, and a control assembly 40. Wherein:

The main body 10 is a generally C-shaped arcuate structure formed by two arc-shaped housings 11 arranged side by side. The main body 10 includes a cutting space 12, a receiving groove 13, and an opening 14. The cutting space 12 is located at a central portion of the main body 10 and is used to accommodate a tube. The receiving groove 13 is located below the cutting space 12 and is a recess corresponding to an outer profile of the roller assembly 30 for receiving the roller assembly 30. The opening 14 is formed on one side of the main body 10 and communicates with the cutting space 12.

The main body 10 further includes a track 15 disposed above the cutting space 12 for receiving at least a portion of the cutting blade member 20. In addition, the main body 10 has two curved slots 16 disposed above the two tracks 15 and communicating with the two tracks 15. In this embodiment, each curved slot 16 is respectively provided with a curved plate 160 and a ball 161. The curved plate 160 covers an upper side of the track 15, and a curvature direction of the curved plate 160 corresponds to that of the track 15. The ball 161 is disposed between the curved slot 16 and the curved plate 160, with two ends thereof respectively abutting against a bottom surface of the curved slot 16 and the curved plate 160, such that the curved plate 160 is fixed above the track 15.

The cutting blade member 20 is disposed on the main body 10, with at least a portion thereof located in the cutting space 12, for cutting a tube positioned in the cutting space 12. Specifically, the cutting blade member 20 includes a cutting blade 21, a blade shaft 22, and a preload member 23.

The cutting blade 21 has a circular blade edge 210 and a circular flange 211, wherein the flange 211 extends outwardly along an axial direction of the blade edge 210, and an outer diameter of the blade edge 210 is greater than an outer diameter of the flange 211. The blade shaft 22 passes through an axial center of the cutting blade 21, such that the cutting blade 21 is rotatable about an axial direction of the blade shaft 22. Two ends of the blade shaft 22 respectively abut against the track 15, allowing the cutting blade member 20 to move along the track 15.

The preload member 23 is a generally U-shaped strip spring, with one end fixed to the main body 10 and another end pressing against an outer peripheral edge of the flange 211 of the cutting blade 21, thereby applying an elastic force (a first preload force) to the cutting blade 21. As a result, the cutting blade 21 tends to move from an inner side of the track 15 toward an outer side thereof, that is, in a direction approaching the opening 14.

The roller assembly 30 is movably disposed in the receiving groove 13 of the main body 10, and includes a roller base 31, two elastic members 32, a first roller 33, and a second roller 34. The roller base 31 has a first roller groove 310, a second roller groove 311, two elastic-member positioning grooves 312, and a cam groove 313. The first roller groove 310 and the second roller groove 311 are respectively formed on two opposite sides of the roller base 31. The two elastic-member positioning grooves 312 are located below the first roller groove 310 and the second roller groove 311 for receiving the two elastic members 32.

The cam groove 313 is formed on a bottom side of the roller base 31, and the roller base 31 forms an abutting surface 314 at a bottom portion of the cam groove 313. The two elastic members 32 are disposed in the elastic-member positioning grooves 312 of the roller base 31, with two ends thereof respectively acting on the main body 10 and the roller base 31, so as to generate an elastic force that biases the roller base 31 to move in a direction away from the cutting blade member 20.

The first roller 33 is pivotally mounted in the first roller groove 310 of the roller base 31 by means of a first roller shaft 330. The second roller 34 is pivotally mounted in the second roller groove 311 of the roller base 31 by means of a second roller shaft 340. In this embodiment, the first roller 33 is located closer to the opening 14 than the second roller 34; alternatively stated, the first roller 33 is located farther from a center of the main body 10 than the second roller 34.

In addition, the roller assembly 30 has a longitudinal axis and a transverse axis that are orthogonal to each other. The longitudinal axis is generally parallel to a moving direction of the roller assembly 30, and the transverse axis is generally perpendicular to the moving direction of the roller assembly 30. In the present embodiment, an outer diameter of the first roller 33 is the same as an outer diameter of the second roller 34, and a height of the first roller 33 along the longitudinal axis is greater than a height of the second roller 34 along the longitudinal axis.

The control assembly 40 includes a cam 41, a knob 42, and a positioning assembly 43. The cam 41 is a polygonal column structure pivotally disposed in the receiving groove 13 of the main body 10, and has a first cam surface 411, a second cam surface 412, a third cam surface 413, a fourth cam surface 414, and a fifth cam surface 415, wherein distances from the respective cam surfaces to an axis center of the cam 41 are different from each other. One of the cam surfaces 411, 412, 413, 414, 415 abuts against the abutting surface 314 of the roller assembly 30, such that a distance between the roller assembly 30 and the cutting blade member 20 is controlled by the cam 41.

For example, when the cam 41 is rotated such that the first cam surface 411 abuts against the abutting surface 314, the roller assembly 30 is adjusted to a first height; when the cam 41 is rotated such that the second cam surface 412 abuts against the abutting surface 314, the roller assembly 30 is adjusted to a second height, and so on. Among these, the first cam surface 411 is closest to the axis center of the cam 41, and the fifth cam surface 415 is farthest from the axis center of the cam 41. One end of the cam 41 extends out of one side of the main body 10 and is connected to the knob 42. Accordingly, rotation of the knob 42 controls the cam 41, and since the cam 41 abuts against the roller assembly 30, rotating the knob 42 adjusts a position of the roller assembly 30.

In the present embodiment, the knob 42 has three auxiliary portions 421 extending radially outward and an indicator portion 422. Included angles between the three auxiliary portions 421 are 120 degrees. The indicator portion 422 is disposed between two of the auxiliary portions 421, and a length of the indicator portion 422 is smaller than lengths of the auxiliary portions 421. The auxiliary portions 421 provide assisting positions for a user to grip and apply force when rotating the knob 42. The indicator portion 422 points to one of a plurality of tube size scales 17 provided on an outer side of the main body 10, so as to indicate to the user which tube size the roller assembly 30 is currently positioned to clamp.

The positioning assembly 43 includes a positioning ball 431, a spring member 432, and a positioning plate 433. The positioning ball 431 and the spring member 432 are disposed in a through hole 416 formed in the cam 41, wherein a penetrating direction of the through hole 416 is generally parallel to an axial direction of the cam 41. Two ends of the spring member 432 respectively abut against a bottom of the through hole 416 and the positioning ball 431, such that the positioning ball 431 protrudes from the through hole 416 to abut against the positioning plate 433.

The positioning plate 433 is disposed in the receiving groove 13 of the main body 10 and has five positioning holes 433a distributed around the positioning plate 433. The five positioning holes 433a respectively correspond to positions of the positioning ball 431 when the five cam surfaces 411, 412, 413, 414, 415 of the cam 41 contact the abutting surface 314. Under a normal condition, when any one of the cam surfaces 411, 412, 413, 414, 415 of the cam 41 abuts against the abutting surface 314, the positioning ball 431 is engaged in a corresponding one of the positioning holes 433a of the positioning plate 433 to form positioning, such that the knob 42 is not easily rotatable. When a greater force is applied to the knob 42, the positioning ball 431 compresses the spring member 432 and disengages from the positioning hole 433a, allowing the cam 41 to be rotated. When another one of the cam surfaces 411, 412, 413, 414, 415 subsequently abuts against the abutting surface 314, the positioning ball 431 is again engaged in another corresponding positioning hole 433a of the positioning plate 433 to form positioning.

According to the above structural configuration, when a user intends to cut a tube T of a corresponding size, the user can rotate the knob 42 until the indicator portion 422 points to a corresponding tube size scale 17, and the roller assembly 30 is moved, by rotation of the cam 41, along the longitudinal axis to a corresponding position. Next, the tube T is disposed in the cutting space 12 of the main body 10. At this time, the cutting blade 21 is continuously pushed rearward by the tube T until the tube T is simultaneously clamped by the cutting blade member 20, the first roller 33, and the second roller 34, thereby forming three-point positioning.

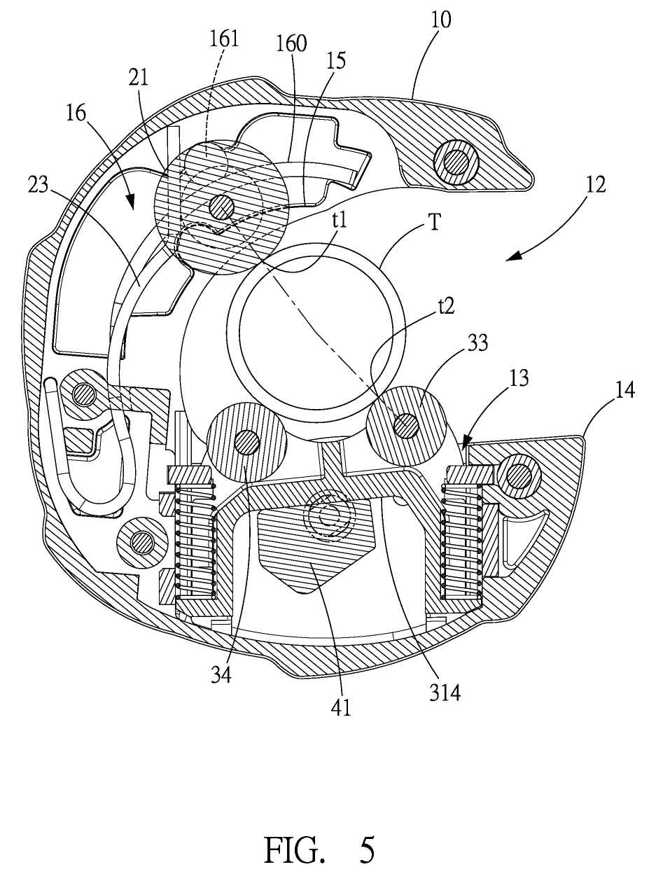

Since a height of the first roller 33 is greater than a height of the second roller 34, an included angle between a first clamping point t1 at which the tube T contacts the cutting blade member 20 and a second clamping point t2 at which the tube T contacts the first roller 33 is always smaller than 180 degrees, as shown in FIG. 5. Accordingly, clamping stability and safety can be effectively improved, and the tube T can be effectively prevented from slipping out of the cutting space 12 during a cutting process.

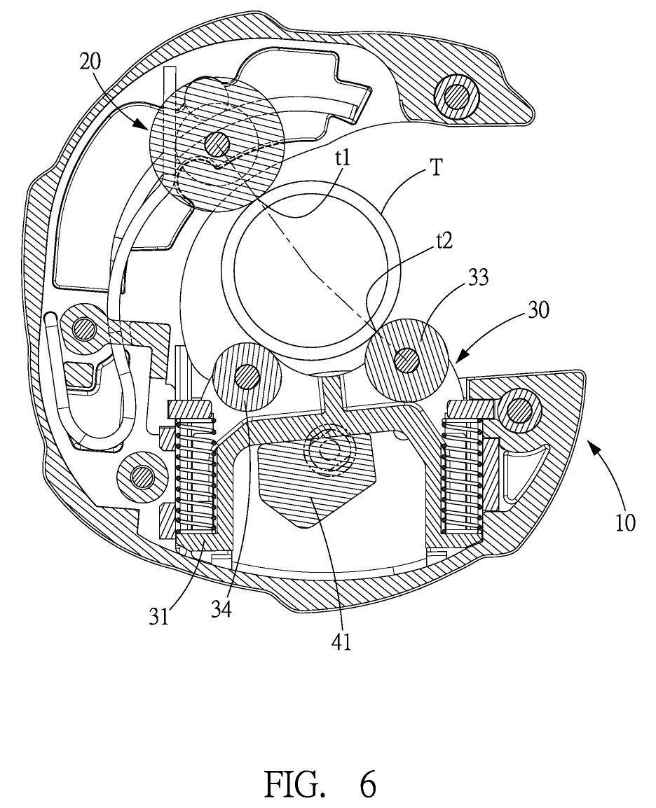

As shown in FIG. 6, a tube cutter capable of cutting tubes with various diameters according to a second preferred embodiment of the present invention has a structure similar to that of the first preferred embodiment. However, in the present embodiment, an outer diameter of the first roller 33 is greater than an outer diameter of the second roller 34, such that an included angle between the first clamping point t1 at which the tube T contacts the cutting blade member 20 and the second clamping point t2 at which the tube T contacts the first roller 33 is always smaller than 180 degrees.

It should be particularly noted that, in the present embodiment, in addition to a configuration in which a height of the first roller 33 along the longitudinal axis is greater than a height of the second roller 34 along the longitudinal axis as in the first preferred embodiment, the structural design further includes the outer diameter of the first roller 33 being greater than the outer diameter of the second roller 34, thereby further enhancing fixing strength of the three-point positioning. However, the present invention is not limited thereto. In another embodiment, even when the first roller 33 and the second roller 34 are maintained at the same height, the outer diameter of the first roller 33 may be greater than the outer diameter of the second roller 34, which likewise allows the included angle between the first clamping point at which the tube T contacts the cutting blade member 20 and the second clamping point at which the tube T contacts the first roller 33 to be always smaller than 180 degrees.

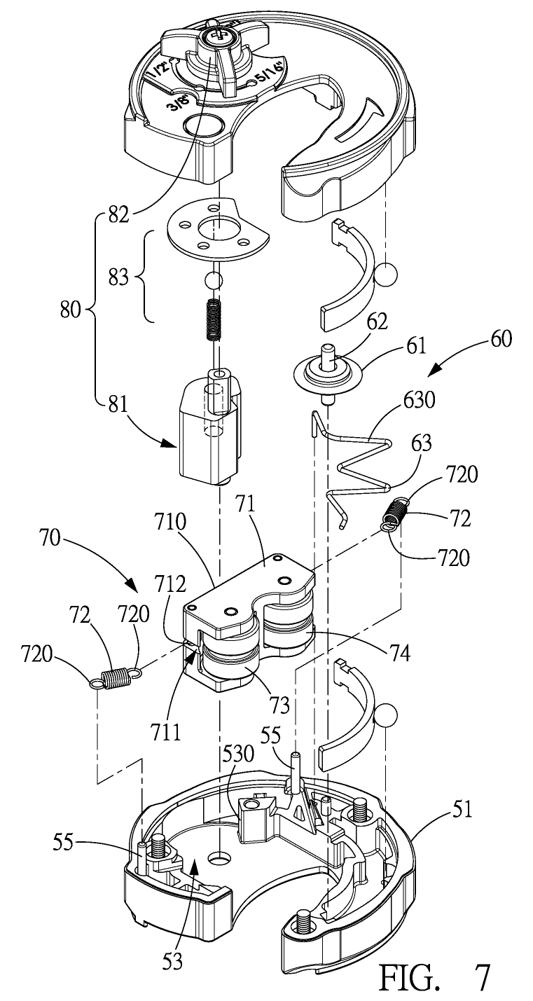

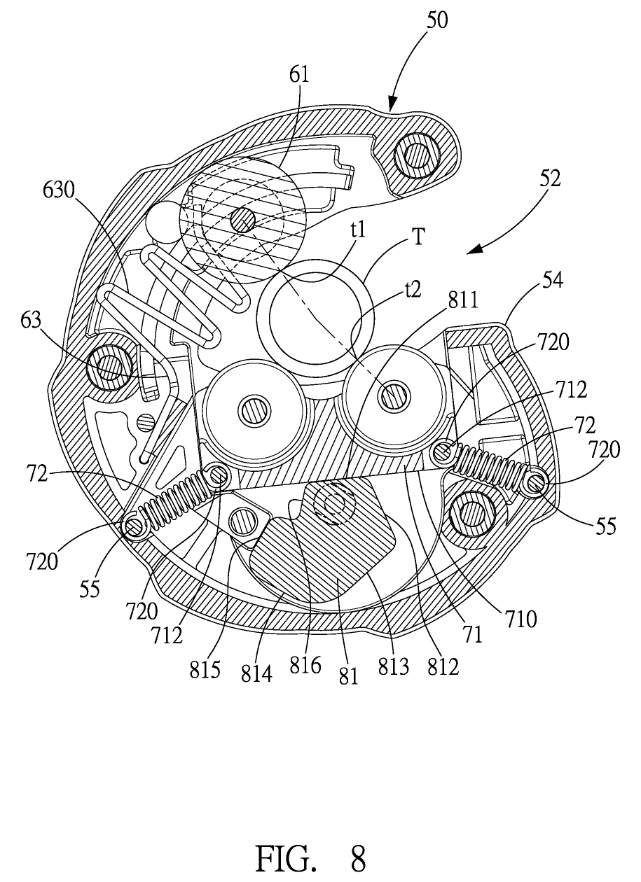

As shown in FIGS. 7 and 8, a third preferred embodiment of the present invention discloses a tube cutter capable of cutting tubes with various diameters, which mainly includes a main body 50, a cutting blade member 60, a roller assembly 70, and a control assembly 80. The main body 50 is formed by combining two arc-shaped housings 51, and includes a cutting space 52, a receiving groove 53, and an opening 54. The structures of the cutting space 52 and the opening 54 are similar to those of the first preferred embodiment, and detailed descriptions thereof are omitted herein for brevity. In the present embodiment, a bottom of the receiving groove 53 is generally arc-shaped, and one side of the receiving groove 53 is provided with a stop block 530. The main body 50 is further provided with two first positioning posts 55 disposed on two opposite sides of the receiving groove 53.

he cutting blade member 60 includes a cutting blade 61, a blade shaft 62, and a preload member 63. The structures of the cutting blade 61 and the blade shaft 62 are similar to those of the first preferred embodiment, and detailed descriptions thereof are omitted herein for brevity. The preload member 63 is a generally W-shaped strip spring and has a plurality of bent segments 630, such that, when the cutting blade 61 is pressed and moves inwardly, the bent segments 630 of the preload member 63 are foldably compressed to provide a preload elastic force.

The roller assembly 70 includes a roller base 71, two elastic members 72, a first roller 73, and a second roller 74. A bottom side of the roller base 71 has an abutting surface 710, two through slots 711 are formed on two opposite sides thereof, and two second positioning posts 712 are formed in the two through slots 711. Heights of the two second positioning posts 712 are greater than heights of the two first positioning posts 55. The two elastic members 72 are respectively disposed on the two opposite sides of the roller base 71. In the present embodiment, each elastic member 72 is a tension spring and has hook portions 720 at two ends thereof, which are respectively hooked to the first positioning post 55 and the second positioning post 712 on the same side, such that the elastic member 72 is obliquely arranged between the roller base 71 and the main body 50, and extension directions of the two elastic members 72 are non-parallel to a moving direction of the roller assembly 70. Two ends of each elastic member 72 are respectively connected to the roller base 71 and the main body 50, thereby applying an elastic force that biases the roller base 71 to move in a direction away from the cutting blade member 60. The structures of the first roller 73 and the second roller 74 are similar to those of the first preferred embodiment, and detailed descriptions thereof are omitted herein for brevity.

The control assembly 80 includes a cam 81, a knob 82, and a positioning assembly 83. The cam 81 is an irregular block body pivotally disposed in the receiving groove 53 of the main body 50, and has a first cam surface 811, a second cam surface 812, a third cam surface 813, a fourth cam surface 814, a stop surface 815, and a transition concave surface 816. Distances from the respective cam surfaces 811, 812, 813, 814 to an axis center of the cam 81 are different from each other, and one of the cam surfaces 811, 812, 813, 814 abuts against the abutting surface 710 of the roller base 71, such that a distance between the roller assembly 70 and the cutting blade member 60 is controlled by the cam 81.

Among these, the first cam surface 811 is closest to the axis center of the cam 81, and the fourth cam surface 814 is farthest from the axis center of the cam 81. The stop surface 815 is adjacent to the fourth cam surface 814. When the first cam surface 811 contacts the abutting surface 710, the stop surface 815 abuts against the stop block 530 of the main body 50, thereby limiting the cam 81 from further rotating upward. By virtue of the configuration of the stop block 530 and the stop surface 815, the cam 81 in the present embodiment is only rotatable in one rotational direction and is not rotatable in an opposite direction. The transition concave surface 816 is formed between the stop surface 815 and the first cam surface 811.

The structures of the knob 82 and the positioning assembly 83 are similar to those of the first preferred embodiment, and detailed descriptions thereof are omitted herein for brevity.

In summary, compared with conventional tube cutters in which a clamping angle may exceed 180 degrees and thereby easily cause a tube to disengage from the tube cutter during a cutting operation, the tube cutter capable of cutting tubes with various diameters provided by the present invention, by virtue of an asymmetric structural design of the first roller 33 and the second roller 34 (having different heights and/or different sizes), allows, when a tube is placed in the cutting space 12, an included angle between a first contact point at which the tube contacts the cutting blade member 20 and a second contact point at which the tube contacts the first roller 33 to be always smaller than 180 degrees. Accordingly, three-point positioning formed by the cutting blade member 20, the first roller 33, and the second roller 34 exhibits significantly improved stability compared with conventional tube cutters, while simultaneously enhancing cutting safety and cutting efficiency.

It must be pointed out that the embodiments described above are only some preferred embodiments of the present invention. All equivalent structures which employ the concepts disclosed in this specification and the appended claims should fall within the scope of the present invention.

1. A tube cutter, comprising:
a main body having a cutting space, wherein one side of the main body has an opening in communication with the cutting space;
a cutting blade member movably disposed on the main body, wherein at least a portion of the cutting blade member is located in the cutting space;
a roller assembly movably disposed on the main body, the roller assembly including a roller base, a first roller, and a second roller, wherein the first roller and the second roller are respectively pivotally mounted on opposite sides of the roller base, and the first roller is positioned closer to the opening than the second roller; and
a control assembly disposed on the main body and connected to the roller assembly, the control assembly being operable by a user to drive the roller assembly to move along a moving direction so as to change a distance between the roller assembly and the cutting blade member;
wherein, when a tube is disposed in the cutting space, the cutting blade member, the first roller, and the second roller respectively abut against an outer wall surface of the tube;
wherein a height of the first roller along the moving direction of the roller assembly is greater than a height of the second roller along the moving direction of the roller assembly, such that an included angle between a first clamping point at which the tube contacts the cutting blade member and a second clamping point at which the tube contacts the first roller is always smaller than 180 degrees.

2. The tube cutter of claim 1, wherein the control assembly includes a cam, the cam being rotatably disposed in the main body, the cam having a first cam surface and a second cam surface, and the roller base having an abutting surface on a bottom side thereof; when the cam is rotated such that the first cam surface abuts against the abutting surface, the roller assembly is adjusted to a first height; when the cam is rotated such that the second cam surface abuts against the abutting surface, the roller assembly is adjusted to a second height.

3. The tube cutter of claim 2, wherein the control assembly includes a knob rotatably disposed on one side of the main body and connected to the cam, such that the knob is operable to drive the cam to rotate; wherein the knob includes a plurality of auxiliary portions arranged radially and an indicator portion, the indicator portion being formed between two of the auxiliary portions, and a length of the indicator portion being shorter than lengths of the auxiliary portions.

4. The tube cutter of claim 2, wherein the control assembly further including a positioning assembly having a positioning ball, a spring member, and a positioning plate; the positioning ball and the spring member being disposed in a through hole formed in the cam, a penetrating direction of the through hole being generally parallel to an axial direction of the cam; the positioning plate being disposed between the cam and the main body; wherein two ends of the spring member respectively abut against a bottom of the through hole and the positioning ball, such that the positioning ball protrudes from the through hole to abut against the positioning plate.

5. The tube cutter of claim 4, wherein the positioning plate has a plurality of positioning holes distributed around the positioning plate, and positions of the positioning holes respectively correspond to positions of the positioning ball when respective cam surfaces of the cam contact the abutting surface.

6. The tube cutter of claim 2, wherein the main body is provided with a stop block adjacent to one side of the cam; the cam further has a third cam surface, a fourth cam surface, and a stop surface; the third cam surface is adjacent to the second cam surface, the fourth cam surface is adjacent to the third cam surface, and the stop surface is adjacent to the fourth cam surface; when the first cam surface abuts against the abutting surface, the stop surface abuts against the stop block, such that the cam is prevented from further rotating in a direction toward the stop block.

7. The tube cutter of claim 1, wherein the roller assembly includes two elastic members disposed on opposite sides of the roller base, extension directions of the two elastic members being generally parallel to the moving direction of the roller assembly; the two elastic members have two ends respectively abutting against the roller base and the main body, thereby applying an elastic force that biases the roller base to move in a direction away from the cutting blade member.

8. The tube cutter of claim 1, wherein an outer diameter of the first roller is greater than an outer diameter of the second roller.

9. A tube cutter, comprising:
a main body having a cutting space, wherein one side of the main body has an opening in communication with the cutting space;
a cutting blade member movably disposed on the main body, wherein at least a portion of the cutting blade member is located in the cutting space;
a roller assembly movably disposed on the main body, the roller assembly including a roller base, a first roller, and a second roller, wherein the first roller and the second roller are respectively pivotally mounted on opposite sides of the roller base, and the first roller is positioned closer to the opening than the second roller; and
a control assembly disposed on the main body and connected to the roller assembly, the control assembly being operable by a user to drive the roller assembly to move along a moving direction so as to change a distance between the roller assembly and the cutting blade member;
wherein, when a tube is disposed in the cutting space, the cutting blade member, the first roller, and the second roller respectively abut against an outer wall surface of the tube;
wherein an outer diameter of the first roller is greater than an outer diameter of the second roller, such that an included angle between a first clamping point at which the tube contacts the cutting blade member and a second clamping point at which the tube contacts the first roller is always smaller than 180 degrees.
